(19) United States
(12) Patent Application Publication
(10) Pub. No.: US 2025/0123025 A1
(43) Pub. Date: Apr. 17, 2025

(54) FILTER MOUNT

(71) Applicants: Lynne Bruhnke, Massapequa Park, NY (US); Daniel Roper, Garden City, NY (US)

(72) Inventors: Lynne Bruhnke, Massapequa Park, NY (US); Daniel Roper, Garden City, NY (US)

(21) Appl. No.: 18/380,181

(22) Filed: Oct. 15, 2023

(51) Int. Cl. F24F 13/28; B01D 46/00

(52) U.S. Cl. CPC F24F 13/28; B01D 46/0005

(57) ABSTRACT

A filter mount, and a method of attaching a filter to an HVAC grille frame, either before or after the framed grille has been installed.

### FIELD OF THE INVENTION

The present invention relates a filter mount, and a method of attaching a filter to an HVAC grille, diffuser, or air handling device frame, either before or after the framed device has been installed.

### BACKGROUND OF THE INVENTION

In HVAC systems containing linear bar grilles or diffusers, it is necessary for there to be a method of cleaning or filtering the air moving throughout the system. There is a need to remove dust and airborne particulate. One method of achieving this is through use of air filters or filtration panels that are installed behind linear bar grilles. These filters are usually installed behind an HVAC linear bar grille that is removing air or pulling air from the area. These are known as return air grilles.

Over time, the air filters become clogged with particulate and must be replaced periodically. These filters are available in a wide range of heights, widths and lengths. These filters are readily available in the marketplace.

In some HVAC systems, after installation and operation, for a period of time, additional filters are needed to improve air quality.

It is known in the art that an HVAC system will have as part of its design, an air filtration system. There are numerous methods of filtering air in an HVAC system. One such method is an air filter known as a dust filter. Air filters and dust filters are commercially available. Air filters require replacement. Air filters have different ratings for the level of particulate they remove from the air. Air quality has become critically important since the Covid pandemic.

It is known in the art that an HVAC linear bar grille may have a perimeter frame. A linear bar grille assembly for an HVAC system will consist of linear bars. The perimeter frame may be in the form of an angle, a Z shape, an L shape or a straight bar. A linear bar grille core will have multiple linear bars running the long dimension. The multiple linear bars will be supported and co-joined with one or more cross members. The cross members are perpendicular to the linear bars. A linear bar grille core may be removable from the frame. A linear bar grille core may be removable from the frame to access a filter, damper or the duct.

It is known in the art that an air filter must remain stationary to allow air in the HVAC system to pass through it. An HVAC system air filter must be accessible. An air filter must not move within an HVAC system.

It is known in the art that an HVAC linear bar grille frame will extend into the HVAC opening or duct. It is known in the art that the air circulating within the HVAC system will pass through the HVAC linear bar grille. It is known in the art that air must pass through the filter. It is known in the art that air passing through the filter and HVAC linear bar grille will exert force. It is known in the art that air passing through the filter and HVAC linear bar grille will exert force and that force will vary. It is known in the art that a filter within an HVAC system must remain stationary.

US patent publication 20120047859 relates to a filter clip for holding a filter media over a supply/return/exhaust of an HVAC system that includes a hook portion that secures to a grid of a suspended ceiling system and a filter holding portion that is connected to a hook portion such that the filter holding portion is biased towards the grid and/or a grille. An air filter placed between the filter holding portion and the grid and/or grille is held against the grid and/or grill until, for example, construction is complete or the filter needs to be changed or removed, thereby covering the supply/return and reducing contamination of the HVAC system from construction dirt/debris.

US patent publication 20150075125 relates to a filter frame assembly comprising a perimeter member surrounding a fluid aperture adapted to accommodate a fluid flow from an upstream direction to a downstream direction. The perimeter member comprises a perimeter upstream surface, a perimeter downstream surface, and a perimeter outer surface connecting the perimeter upstream surface to the perimeter downstream surface. A gasket carrier is attached to the perimeter member and comprises a carrier portion facing generally away from the fluid aperture and a first portion sealing member projecting from the carrier outer portion.

### SUMMARY OF THE INVENTION

The present invention relates to a filter mount that provides a structure to hold a filter in place behind an air handling device, including a framed linear bar grille or diffuser.

The present invention relates to a filter mount that is comprised of a filter capture ledge or angle, and a mount extension. The mount extension supports the angled filter ledge. The filter mount captures an air handling device. It is an object of the present invention for the air handling device to be a framed linear bar grille or a slot diffuser. It is an object of the present invention for the depth of the mount extension to be sufficient to support the thickness of the filter. It is an object of the present invention for the depth to vary. The filter mount is further comprised of a U-clip base. The U clip base has a channel or opening gap where the air handling device frame is inserted. The U-clip base comprises a shorter side and a longer side. The difference in the height of the sides assists with installing the filter mount on an angle.

It is an object of the present invention for a filter to be captured or contained above the filter capture ledge. The U-clip base provides a projection stop for the filter so it can't move up and down. The U-clip base has a larger side, a smaller side and a channel. An attachment device helps hold the air handling device within the channel.

It is an object of the present invention for the filter mount to have a filter capture ledge, and a U-clip base, which has an opening or channel, a longer side and a shorter side, wherein a frame of an air handling device is held within the channel between the sides. It is an object of the present invention for the frame of the handling device to be held by a fastening device placed in a through hole.

It is an object of the present invention for a filter mount having a filter capture ledge, a mount extension, a U clip base, and a smaller side and a larger side each side of the channel. In this configuration the filter mount can be attached to an air handling device on an angle.

It is an object of the present invention for the filter mount to be removed and re-positioned along the air handling device frame.

The present invention relates to a method of attaching a filter to an air handling device frame with a filter mount either before or after the framed device has been installed.

It is an object of the present invention for the filter mount to be designed for framed, air handling devices with removable cores.

It is an object of the present invention for the filter mount to be attached to any air handling device frame.

It is an object of the present invention for the filter mount to be attached to the bottom of an air handling device frame before or after the air handling frame is installed.

It is an object of the present invention for the filter mount to be attached to the bottom of an air handling device frame on any of the four sides of the frame.

It is an object of the present invention for the filter mount to be attached to the bottom of the air handling device frame in at least three locations.

It is an object of the present invention for the filter mount to be attached to the bottom of an air handling device frame without hand tools.

It is an object of the present invention for the filter mount to be attached to the bottom of an air handling device frame with a press fit pin.

It is an object of the present invention for the filter mount to be attached to the bottom of an air handling device frame with construction adhesive.

It is an object of the present invention for the filter mount to be attached to the bottom of an air handling device frame with high strength bonding foam tape.

It is an object of the present invention for the filter mount to be constructed of plastic or metal.

It is an object of the present invention for the filter mount to comprise a U-shaped channel which wraps around an air handling device, including a linear bar grille frame. It is an object of the present invention to utilize an upward motion wherein the filter mount is slid onto the air handling device, including a linear bar grille frame.

It is an object of the present invention for the U-shaped channel to be squared or radiused at the bottom. It is an object of the present invention for the U-shaped channel to have one side that extends higher than the other side. This difference in height enables the installer to angle the mount onto the air handling device, making installation easier.

It is known that different heights of the channel sides will provide an angled approach to the framed bottom.

It is an object of the present invention to secure the filter mount to the air handling device by construction adhesive or high strength foam tape that may be placed inside the U-shaped channel.

It is an object of the present invention to secure the filter mount to the air handling device by a pin that is inserted into a through hole in the U shaped channel. It is an object of the present invention, when a pin is used to attach the filter mount to the bottom of the air handling device, the pin is inserted into the hole using standard pliers. It is an object of the present invention for the pin to be made of metal or plastic material.

It is an object of the present invention for an extension to project downward from the U-shaped channel to a right angle support ledge. It is an object of the present invention for the extension length to vary from 1 inch to 2.5 inches to accommodate a range of filter thicknesses. It is known in the art that filter thickness may vary. It is further known that filter thickness may vary and a filter mount may adjust to a range of filter heights.

It is an object of the present invention for the right angle support to project a minimum of 0.50 inches away from the extension length. It is an object of the present invention for the right angle support to be the surface on which the filter rests. It is an object of the present invention for the right angle support to be longer than 0.50 inches.

It is known in the art that filter mounts will provide a more secure filter in installation if at least 3 mounts are used on opposite sides of the frame.

It is an object of the present invention for a projection and base of the U-shaped channel to create a recess for the filter to be positioned in. It is known in the art that the filter must fit securely in the recess to avoid vibration when air passes through the filter.

### BRIEF DESCRIPTION OF THE DRAWINGS

FIG. 1 shows the filter mount attached to an air handling device and specifically a linear bar grille frame.

FIG. 2 shows the filter mount attached to a linear bar grille frame, and further containing a filter.

FIG. 3 shows the filter mount attached to a linear bar grille frame.

FIG. 4 shows the filter mount being attached to a linear bar grille frame at an angle.

### DETAILED DESCRIPTION OF THE INVENTION

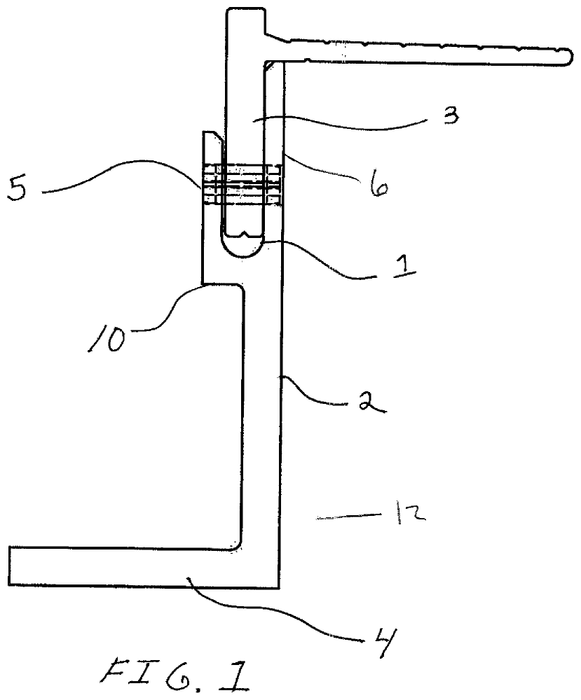

FIG. 1 shows a filter mount 12 attached to an air handling device, specifically a linear bar grille frame 3. The filter mount 12 is comprised of a filter capture ledge or angle 4, and a mount extension 2 that supports the filter. The depth of the mount extension 2 is sufficient to support the thickness of a filter. The depth can be adjustable. The filter mount 12 is further comprised of a U-clip base 10. The U clip base 10 has a channel or opening gap 1 to which the linear bar grille frame 3 is inserted into the filter mount 12. The filter mount 12 is shown with sides 5 and 6. Side 5 is the shorter side and side 6 is the longer side. The difference in the height of the sides 5 and 6 assists with inserting the filter mount 12 on an angle.

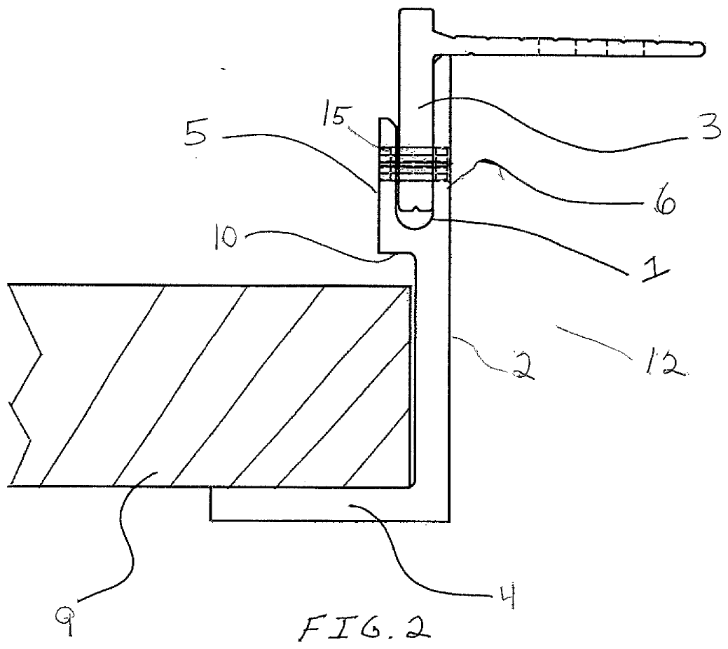

FIG. 2 shows a filter mount 12 having a filter capture ledge or angle 4, a mount extension 2, wherein a filter 9 is captured or contained above the filter capture ledge 4. The U-clip base 10 provides a stop for the filter 9 so it can't move up and down. The U-clip base 10 has a larger side 6, a smaller side 5 and a channel 1. An attachment device 15 helps hold the linear bar grille frame 3 in the filter mount 12.

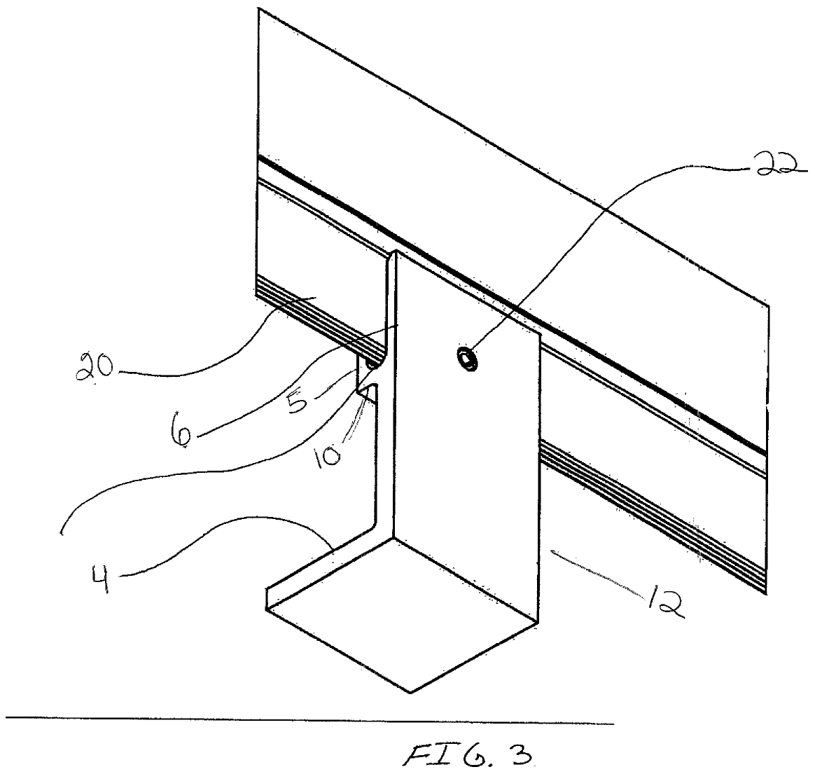

FIG. 3 shows a filter mount 12 having a filter capture ledge 4, and a U-clip base 10, which has an opening or channel 1, a longer side 6 and a shorter side 5, wherein a frame 20 of a device is held within the channel 1 between sides 5 and 6, and is further held by a fastening device placed in through hole 22.

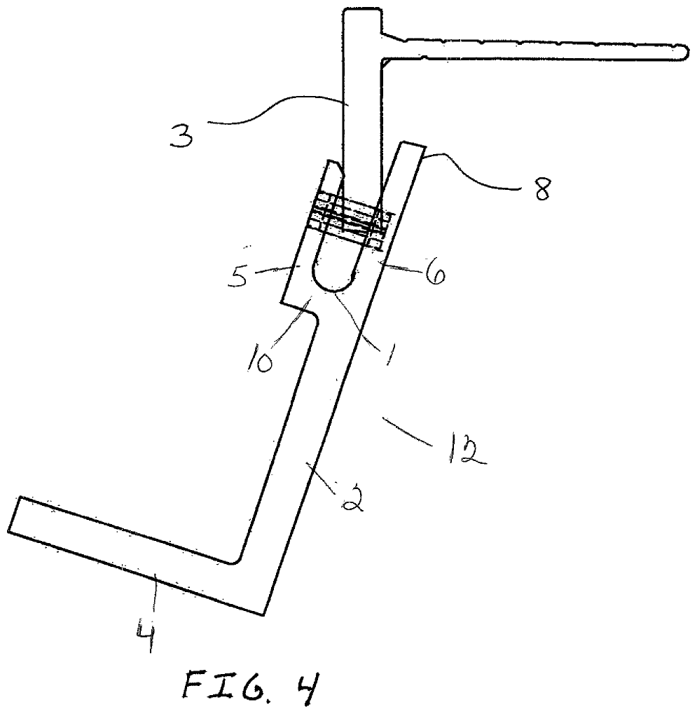

FIG. 4 shows a filter mount 12 having a filter capture ledge 4, a mount extension 2, a U dip base 10, and smaller side 5 of the channel 1 and larger side 6 of the channel 1. This figure shows how the filter mount 12 can be attached to an air handling device 3 on an angle.

1. A filter mount comprising:
a filter capture ledge or angle;
a mount extension;
a U-clip base comprising two sides with a channel or opening gap between said sides;
an attachment device;
said filter mount capturing a frame of an air handling device.

2. The filter mount of claim 1 that provides a structure to hold a filter in place behind an air handling device, including a linear bar grille or diffuser.

3. The filter mount of claim 1 wherein said mount extension supports a filter, and said filter is contained above said filter capture ledge or angle.

4. The filter mount of claim 1 wherein said air handling device is a linear bar grille or a slot diffuser.

5. The filter mount of claim 2 wherein the depth of said mount extension is sufficient to support the thickness of said filter.

6. The filter mount of claim 5 wherein depth of said mount extension is adjustable.

7. The filter mount of claim 1 wherein said channel or opening gap is where said air handling device frame is inserted.

8. The filter mount of claim 1 wherein said U-clip base comprises a shorter side and a longer side, that assists with installing said filter mount on an air handling device frame that has already been installed.

9. The filter mount of claim 2 wherein said U-clip base provides a stop for said filter so it can't move up and down.

10. The filter mount of claim 1 wherein said attachment device helps to hold said air handling device frame within said channel.

11. The filter mount of claim 2 wherein said the filter is removed and re-positioned along said air handling device frame.

12. The filter mount of claim 2 wherein said filter is attached to said grille frame by said filter mount before said framed grille is installed.

13. The filter mount of claim 2 wherein said filter is attached to said grille frame by said filter mount after said framed grille is installed.

14. The filter mount of claim 2 wherein said filter mount is used with frame having removable cores.

15. The filter mount of claim 1 wherein said filter mount is attached to any linear bar grille frame.

16. The filter mount of claim 1 wherein said filter mount is attached to bottom of an air handling device on any of four sides of said air handling device.

17. The filter mount of claim 1 wherein said filter mount is attached to bottom of said air handling device in at least three locations.

18. The filter mount of claim 1 wherein said filter mount is attached to bottom of said air handling device frame with no tools.

19. The filter mount of claim 1 wherein said filter mount is attached to bottom of said air handling device frame with a press fit pin.

20. The filter mount of claim 1 wherein said filter mount is attached to bottom of said air handling device frame with construction adhesive.

21. The filter mount of claim 1 wherein said filter mount is attached to bottom of said air handling device frame with high strength bonding foam tape.

22. The filter mount of claim 1 wherein said filter mount is constructed of plastic or metal.

23. The filter mount of claim 1 wherein said channel of said U-clip base wraps around said air handling device frame.

24. The filter mount of claim 1 wherein said U-clip base is squared or radiused at the bottom.

25. The filter mount of claim 1 wherein to secure said filter mount to said air handling device, construction adhesive or high strength foam tape is placed inside said channel of said U-clip base.

26. The filter mount of claim 1 wherein said filter mount is secured to said air handling device by a pin inserted into a through hole in said U-clip base.

27. The filter mount of claim 1 wherein said mount extension projects downward from said U-clip base to a filter capture ledge being a right angle support.

28. The filter mount of claim 27 wherein said mount extension has a length from 1 inch to 2.5 inches to accommodate a range of filter thicknesses.

29. The filter mount of claim 1 wherein said capture ledge projects a minimum of 0.50 inches away from said mount extension length.

30. The filter mount of claim 2 wherein said capture ledge acts as surface on which said filter rests.

31. The filter mount of claim 30 wherein said capture ledge is longer than 0.50 Inches.

32. The filter mount of claim 2 wherein said capture ledge and base of said U-clip create a recess for said filter to be positioned in
